(19) United States
(12) Patent Application Publication
(10) Pub. No.: US 2008/0149434 A1
(43) Pub. Date: Jun. 26, 2008

(54) PARKING BRAKE AND ACTUATOR MECHANISM

(75) Inventors: Manuel Barbosa, Novi, MI (US); Philip Jedele, Ypsilanti, MI (US); Lakshmi Narayanan .V, Farmington Hills, MI (US)

Correspondence Address: DOBRUSIN & THENNISCH PC, 29 W LAWRENCE ST, SUITE 210, PONTIAC, MI, 48342, US

(73) Assignee: Akebono Corporation (North America)

(21) Appl. No.: 11/942,082

(22) Filed: Nov. 19, 2007

Related U.S. Application Data
(60) Provisional application No. 60/867,689, filed on Nov. 29, 2006.

(51) Int. Cl. F16D 51/00

(52) U.S. Cl. 188/72.9

(57) ABSTRACT

The present invention is predicated upon improved vehicle brake assemblies, parking brake assemblies, parking brake actuators, or combinations thereof, having simplified attachment features, reduced friction and improved duty cycle over previously known devices.

### CLAIM OF PRIORITY

This application claims the benefit of the filing date of U.S. Provisional Application No. 60/867,689, filed Nov. 29, 2006, the contents of which are hereby entirely incorporated by reference for all purposes.

### FIELD OF THE INVENTION

The present invention is predicated upon an improved system and method for providing a parking brake assembly and more specifically a parking brake actuator.

### BACKGROUND OF THE INVENTION

In the field of automotive manufacturing, parking brake assemblies are commonly used to prevent movement of a vehicle. In a typical parking brake assembly, an operator engagement feature, such as a pedal, lever or otherwise, is providing for causing engagement and disengagement of a parking brake actuator mechanism. Typically the operator engagement feature is remotely located and attached to the parking brake actuator, such as through a linkage (e.g. cable, wire, or otherwise), for causing movement to one or more components of the actuator. Through this movement and the configuration of the parking brake actuator, the shoes or pads of the vehicle braking system move to frictionally engage a corresponding component, such as a brake drum, rotor or otherwise.

In one particular application, a parking brake assembly may include a drum-in-hat brake system. In this application, the assembly commonly includes a parking brake actuator mechanism linkably attached to an engagement feature and configured to radially move the brake shoes outwardly against an interior surface of a brake drum, in response to operator input. Upon release of the actuator, the engagement feature returns to an original position thereby allowing the brake shoes to return to an original position through one or more springs associated with the drum brake system.

Examples of parking brake assemblies can be found in U.S. Pat. Nos. 1,913,156, 2,118,188, 4,678,067, 4,844,212, 4,887,698, 5,180,037, 5,400,882, 5,529,149, 5,957,247, 6,412,609, 6,464,046 and 6,666,302, all incorporated by reference for all purposes. The present invention improves on these parking brake assemblies as shown and described herein.

### SUMMARY OF THE INVENTION

The present invention provides improved parking brake and actuator assemblies having improved duty cycle and lower production cost as compared to prior assemblies.

In one aspect, the present invention provides an actuating mechanism for a parking brake. The actuator mechanism includes a lever having a first pivot site and a second pivot site. The actuating mechanism also includes a first strut configured to pivotally engage the actuating lever at the first pivot site and a second strut configured to engage the actuating lever at the second pivot site. Upon displacement of the actuating lever, the first strut, the second strut, or both, are moveable generally longitudinally, relative to each other, for engaging one or more braking elements. This causes contact surfaces of the braking elements (e.g. a brake pad or shoe) to move into or out of braking engagement with a corresponding opposing braking component (e.g. a rotor or brake drum). In this aspect, the positioning of the actuating mechanism is achieved through engagement with the one or more braking elements. Also, optionally the first strut, second strut and/or lever may be reversible for allowing for installation on a vehicle brake assembly located on either side of the vehicle, or for permitting easy correction of improperly installed components.

In another aspect, the present invention provides a parking brake assembly. The assembly includes a housing and one or more braking elements having contact surfaces pivotally mounted with respect to the housing. The one or more braking elements are adapted to rotate outwardly from an axis to provide contact with a corresponding braking component. The assembly further includes an actuating mechanism that includes: a) a lever having a first pivot site and a second pivot site; b) a first strut pivotally engaging the actuating lever at the first pivot site and having a first longitudinal axis; and c) a second strut engaging the actuating lever at the second pivot site and having (i) a second longitudinal axis that is generally in parallel alignment with the first longitudinal axis and (ii) a contact surface engaging a first notch formed in at least one of the braking elements. Upon displacement of the actuating lever, the first strut, the second strut or both are moved generally longitudinal relative to each other for bringing the contact surface of at least one of the braking elements into or out of braking engagement with the corresponding braking component.

Still further, in some of the additional aspects, the present invention also provides the ability to mount the actuator mechanism outboard from the anchor block, which is used to assist in positioning of the braking elements. Also, the configuration of the braking elements and actuator mechanism allows the actuator mechanism to be mounted directly to the braking mechanism, without the use of additional mounting features. Further, the actuator mechanism may be configured free of mechanical retention means (such as rivets, mounting features associated with an anchor block, or otherwise) for maintaining position of the actuator components with respect to each other. Still further, during actuation of the actuator mechanism, the contact area between the actuator and braking elements are substantially free of frictional forces.

It should be appreciated that the above referenced aspects and examples are non-limiting as other exists with the present invention, as shown and described herein. For example, any of the above mentioned aspects or features of the invention may be combined to form other unique configurations, as described herein, demonstrated in the drawings, or otherwise.

### BRIEF DESCRIPTION OF THE DRAWINGS

FIG. 1 illustrates an exploded perspective view of a brake assembly including one embodiment of a parking brake mechanism of the present invention.

FIG. 2 illustrates a front view of the brake assembly and parking brake mechanism shown in FIG. 1.

FIG. 3 illustrates a perspective view of a parking brake mechanism according to the teachings of the present invention.

FIG. 4 illustrates an exploded perspective view of the parking brake mechanism shown in FIG. 3.

FIGS. 5A and 5B illustrate a cross-section view of the parking brake mechanisms, shown in FIG. 2, in different positions.

FIG. 6 illustrates a cross-section view of the parking brake mechanism shown in FIG. 3.

FIG. 7 illustrates a side view of a first actuating lever of a parking brake mechanism of the present invention.

FIG. 8 illustrates a side view of a second actuating lever of a parking brake mechanism of the present invention.

FIGS. 9 through 11 illustrate different engagement configurations between parking brake mechanisms and braking elements of the present invention.

### DETAILED DESCRIPTION

In general, the present invention is predicated upon an improved vehicle brake system. More particularly, the present invention is predicated upon an improved parking brake actuator for improving a parking brake assembly of a vehicle braking system.

The parking brake assembly provides advantages over the prior art by improving longevity of the parking brake system. For example, in one aspect, this advantage is achieved through the unique configuration of the components comprising the parking brake actuator. In one possible construction, this may also be achieved through a substantial avoidance of surface friction, wear, or both, often encountered by the components during actuation of the parking brake system. That is, the present invention makes possible the elimination of camming of a lever against a brake shoe.

In contrast to many of the previous system, the contact surfaces between the parking brake actuator mechanism and the corresponding braking element (e.g. brake shoe, pad, etc.) are substantially free of frictional resistance when an edge associated with an actuator lever engages a brake shoe. The above improvement is achieved through the modification of the parking brake actuator to remove the cammed surface used to cause movement of the braking element in order to engage a corresponding braking component (e.g. brake drum, rotor, or otherwise). Thus in one particular embodiment, a rotating lever, having offset pivotal connections, is used in the actuator to cause movement of connecting members to the braking element.

The parking brake assembly also provides the ability to reduce manufacturing cost of the brake assembly by improving the brake assembly. The assembly also provides for improved installation, inspection and replacement of assembly components. For example, in one aspect, the components forming the parking brake actuator mechanism are mounted to, and kept in place by, the component forming the brake assembly and more specifically the braking element upon which the actuator acts (e.g. brake shoe, pad etc.). The actuator assembly can be carried in the brake assembly by an inwardly located anchor member. In addition thereto, or as an alternative, the actuator assembly can be held in place by an opposing brake shoes or pads.

In another aspect, the actuator mechanism employs a substantially flat and/or symmetrical lever that is readily removable and reversible to be interchangeable between brake assemblies existing on either side of an axle. However, the lever may be bent or shaped (e.g. L-shaped or otherwise) to form a non-flat member that my still be interchangeable. This interchangeability is the result of the reversibility of the components wherein one or more of the components making up the parking brake actuator mechanism, and preferably all of the components, are reversible to adapt to application or installation on opposite sides of a vehicle. This is in contrast to many of the prior art brake components which require specific components for the braking systems on each side of the axle. However, it is contemplated that the actuator mechanism, and/or components thereof, may not be reversible but instead specifically designed for a specific brake assembly, wheel or axel, or side thereof.

In yet another aspect, as desired, the parking brake actuator mechanism may be formed substantially free of mechanical fasteners (e.g. rivets, bolts, or otherwise) for fastening the components of the actuator together (e.g. permanently fastened) or for attachment of the actuator mechanism to the braking system. As should be appreciated, the elimination of fastening components reduces cost by eliminating not only the fastening component, but also eliminating the time necessary to utilize such components.

Of course, other aspects of the present invention, as shown and described herein, also contribute to the above mentioned advantageous and other advantageous as implicitly or explicitly described herein.

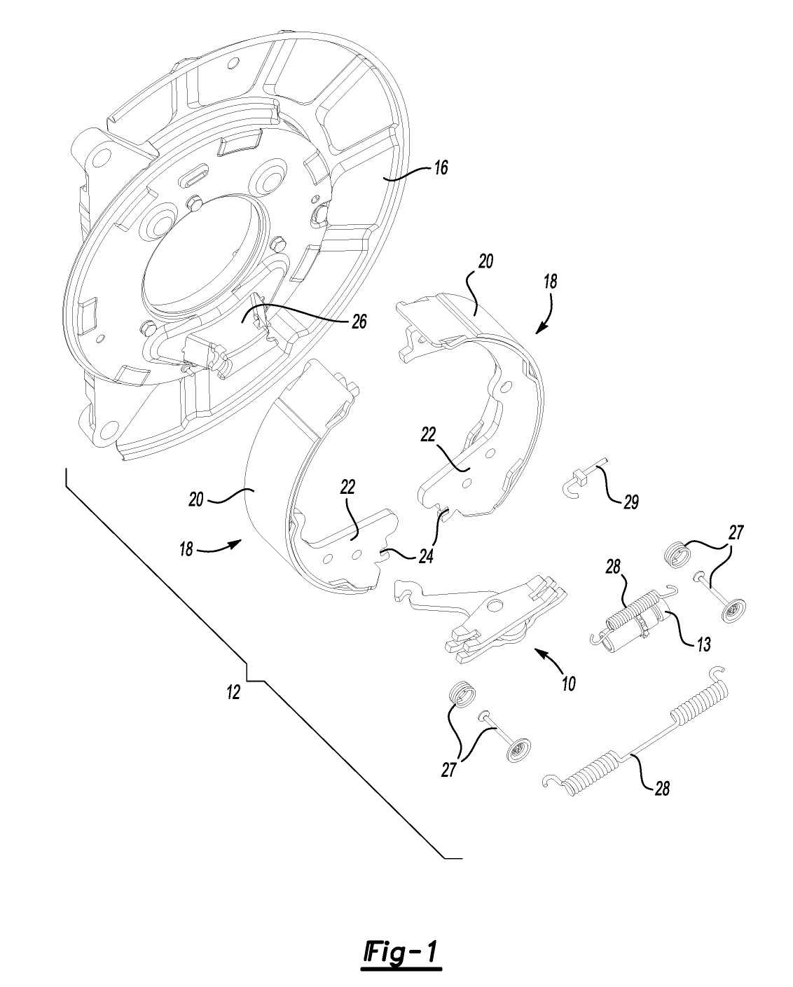

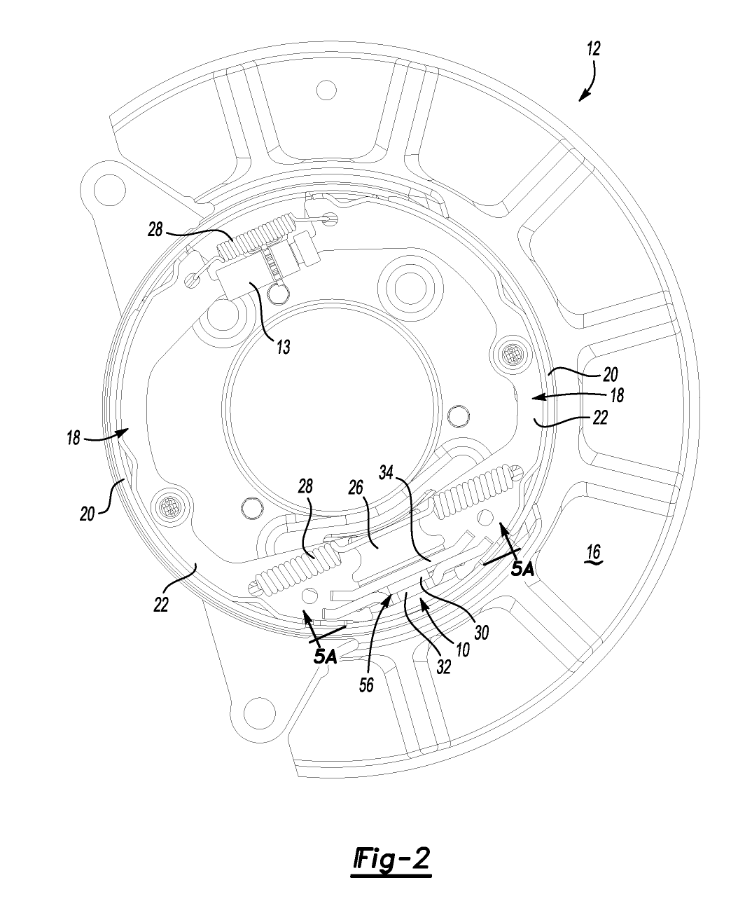

In general, referring to FIGS. 1 and 2, the present invention provides a parking brake actuator mechanism 10 for use with a brake assembly 12. The parking brake assembly is adapted for use and more preferably to be incorporated into one or more braking systems of a vehicle. Typically, this includes a single brake assembly associated with a wheel of an axle, but of course may extend to more than one including all of the vehicle wheels.

The brake assembly 12 may include any brake system used with a vehicle. Preferably, at least one of the brake assemblies includes a parking brake assembly therewith. The brake assembly may include caliper brakes, drum brakes or otherwise. Such braking systems include one or more brake pads or shoes configured for engagement with a rotating member of the vehicle wheel, such as brake rotor or drum. The actuation of the brake system components generally comprise the hydraulic use of brake fluid to fluidly apply a load against a brake component, such as a piston, which is further connected to one or more components configured to cause or otherwise move the braking elements used to engage the moving components of the wheel. In contrast, the actuation of the parking brake assembly or mechanism typically utilizes mechanical means such as levers, cables or the like.

In one particular advantageous application, the parking brake assembly is utilized with a drum brake assembly, and particularly a drum in hat assembly. The drum brake assembly includes a housing 16 for the mounting of various components of the brake assembly and optionally attachment to the wheel or axle of the vehicle. In one configuration, the housing comprises a mounting plate formed through a stamping or casting procedure, such as commonly done in shaping metal components.

The housing 16 includes one or more mounting structures for the mounting of one or more braking elements (e.g. a shoe) 18 which may further include a friction pad 20 for engagement with a corresponding braking structure, such as a brake drum or rotor, and a support member 22 therefor.

In one preferred configuration, the support members 22 of the braking elements 18 are configured for engagement with the parking brake actuator mechanism 10 at a first end and an adjustment mechanism 13 at a second end. Still further, in one highly preferred configuration, as discussed further herein, the support members of the braking element may include one or more notch support members or portions 24 for engagement with the parking brake actuator at one or more locations. For example, the support member of the braking element may be notched so that it can effectively engage and co-act with the actuator mechanism.

In one approach, the actuator mechanism is carried in the assembly by a suitable carrier that positions the mechanism so that it remains generally in a fixed location relative to the lever of the actuator mechanism but still allows the individual components to translate relative to each other for engagement with a brake element, such as a shoe or pad. One approach is to employ an anchor block 26 for maintaining the position and/or for guiding the braking elements during engagement with the corresponding braking structure. By example, one suitable anchor block can be found in U.S. patent application Ser. No. 11/522,552, filed on Sep. 14, 2006, herein entirely incorporated by reference for all purposes. In one preferred configuration, the anchor block is located inboard (i.e. toward the center of the assembly) with respect to the parking brake actuator. It is also possible that it can be located on the outboard side of the braking element.

The brake assembly may further include one or more biasing members 28 (e.g., spring or otherwise) for providing return force for the braking elements. The one or more biasing members provide returning force of the braking elements during both the application of the brakes during typical operating use and during application of the parking brake system of the present invention. As shown, the brake assembly may also include spring biased mounting features 27 for providing pivotal attachment of the braking elements 18 to the housing 16.

It should be appreciated that other components associated with a typical brake drum assembly may be utilized and/or otherwise incorporated with the braking system of the present invention. Such additional features may be found in copending commonly owned U.S. patent application Ser. No. 11/522,552, filed on Sep. 14, 2006. Such features may also be found in commonly owned U.S. Pat. Nos. 7,070,025, 7,044,275, 6,454,062, 6,328,391, 6,321,889, 6,290,036, 6,286,643, 6,186,294, 6,131,711, 6,119,833, 6,059,077, 5,964,324, 5,404,971, 5,305,861, 5,125,484, 5,038,898, 4,919,237, 4,782,923, 4,303,148, 4,270,634, or otherwise, all entirely incorporated herein for all purposes.

The parking brake assembly includes a parking brake actuator mechanism 10 for causing engagement of one or more braking elements 18 with a corresponding braking component. The parking brake assembly includes linkages 29 for connecting the actuator to an operator engagement feature, such as a pedal, lever, or otherwise, for causing engagement and disengagement of the parking brake actuator mechanism 10. Typically the operator engagement feature is remotely located, within a cabin of a vehicle, and linkably attached to the parking brake actuator, via a linkage, cable, wire, or otherwise.

The parking brake actuator mechanism 10 is mounted to a portion of the brake assembly, preferably with one or more brake shoes or other braking element, and more preferably between two opposing braking elements 18. In one configuration, the actuator mechanism is located outboard of an anchor block 26 of the brake assembly to improved accessibility and reduce manufacturing cost. The actuator mechanism includes two generally opposing (and optionally contacting) strut members, one or both being configured to engage the braking elements for driving the braking elements into braking engagement with a brake drum or other braking surface. Upon receiving force from an operating engagement feature, the struts of the actuator mechanism are configured to move with respect to one another to transfer motion originating from the engagement feature to the brake shoe or other braking elements 18 of the brake assembly 12. The engagement between the struts and brake shoe or other element generally will from a direct contact force and thus may be substantially free of sliding and frictional movement between the contact surfaces of the actuator mechanism and the braking elements of the braking system. This is because the force applied to the braking element comprises an axial force as opposed to a rotational cam (e.g. sweeping) force.

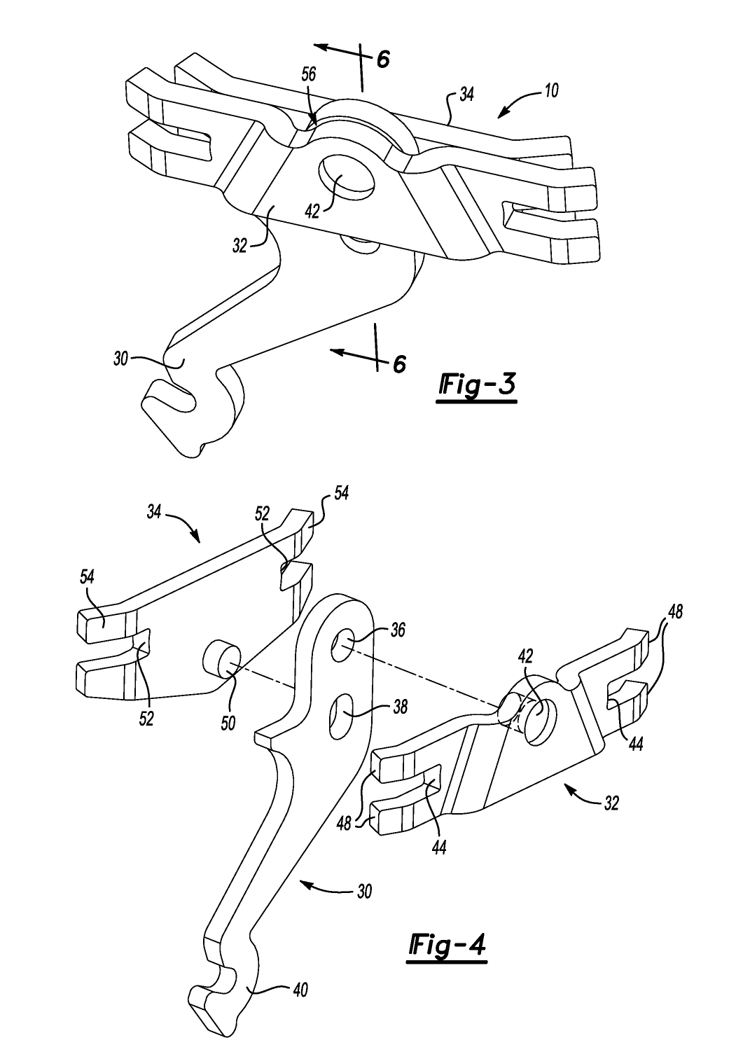

Referring to FIGS. 3 through 6, one configuration of a parking brake actuator mechanism 10 is shown. In general, the parking brake actuator includes an actuating lever 30 configured to be linkably attached to the operator engagement feature of the parking brake assembly, via linkage 29. Upon application of a force, such as by the tensioning of the linkage, the lever is caused to rotate along a plane for causing one or more, and preferably a first strut 32 and a second strut 34, to move relative to each other. For example, as the lever is rotated each strut moves longitudinally, in generally different (e.g. opposite) directions, relative to each other and also generally in the same or parallel planar direction as the motion of the lever.

The actuating lever 30 extends along a longitudinal axis and includes a first end portion for engagement with the first and second strut 32, 34 and a second end portion for engagement with linkage 29. The lever engages the first and second strut 32, 34 through a pivotal engagement. In the configuration shown, the actuating lever includes openings through which pins or other elongated projecting members from the first and second strut pass. For example, the actuating lever includes a generally round aperture 36 and a generally elongated slot 38 for receiving projecting members, such as a pin or otherwise, that are associated, connected or formed with the first and second strut. Alternatively, it is contemplated that holes or slots associated with the lever may be included on the struts wherein the lever includes one or more projections for engagement therewith. Still further, as shown in FIGS. 7 and 8, it is contemplated that the location of aperture 36 and slot 38 may be switched.

The lever also includes a connector 40 for attachment to an engagement feature or a connecting linkage 29 therefore. In one embodiment, the shape of the lever may be configured as a hook to provide improved transfer of leverage force from the operator engagement feature to the components of the actuator mechanism. Advantageously, this hook configuration also aids in securing engagement with linkage 29. Other lever shapes may be employed as desired.

Referring to FIG. 4 the first strut 32 comprises a first elongated member having a first longitudinal axis. The first strut includes a central portion and opposing distal portions. The strut includes a first face, a second face, an upper portion, and lower portion, and a projection 42 extending from the first face having a free end, for defining a pivot axis. As shown, the projection may be integrally formed with the first strut; however, the projection may also comprise a separate component, such as a pin, or the like. The projection and pivot axis are located generally toward the center of the first strut and in the upper portion of the strut.

The distal portions of the first strut are located in a different plane relative to the central portion and are generally coplanar with the free end of the projection. As shown, the distal portions include contact surfaces 44 for engagement with the braking elements 18 of the brake assembly 12, and optionally with one or more notched portions 24 formed in the braking elements. Preferably, the distal portions further include one or more, and preferably two fingers 48, extending along the axis to form a forked configuration for assisting in the engagement and maintaining of position of the first strut with respect to the braking element. As should be appreciated, the fingers are located on opposite sides of the support member 22 and act to prevent or limit movement of the first strut with respect to the braking element.

The second strut 34 comprises a second elongated member having a second longitudinal axis. The second strut includes a central portion and opposing distal portions. As with the first strut, the second strut also includes a first face, a second face, an upper portion, a lower portion, and also includes a second projection 50 from the second face having a free end, for defining a second pivot axis. The projection may be integrally formed with the second strut; however, the projection may also comprise a separate component, such as a pin, or the like. The projection and pivot axis are located generally toward the center of the second strut and in the lower portion of the strut.

The distal portions of the second strut are located in a different plane relative to the central portions and extend away from the free end of the projection. The distal portions include contact surfaces 52 for engagement, and application of force, with the braking elements 18 of the brake assembly 12, and optionally with one or more notched portions 24 formed in the braking elements. Preferably, the distal portions further include one or more, and preferably two fingers 54, extending along the axis to form a forked configuration for assisting in the engagement and maintaining of position of the second strut with respect to the brake shoe or other braking element. The fingers substantially limit movement towards and away from the brake assembly housing.

Referring again to the entire actuator mechanism, as shown in FIGS. 3, 5A, 5B and 6, the first strut 32, second strut 34 and actuator lever 30 join together to form a linking relationship. In doing so, the first strut is in opposing relation with the second strut such that at least a portion of the second face of the second strut contacts at least a portion of the distal portions of the first face of the first strut. This relationship forms a gap 56 between a portion of the first face of the first strut and the second face of the second strut adjoining the central portion of the first strut.

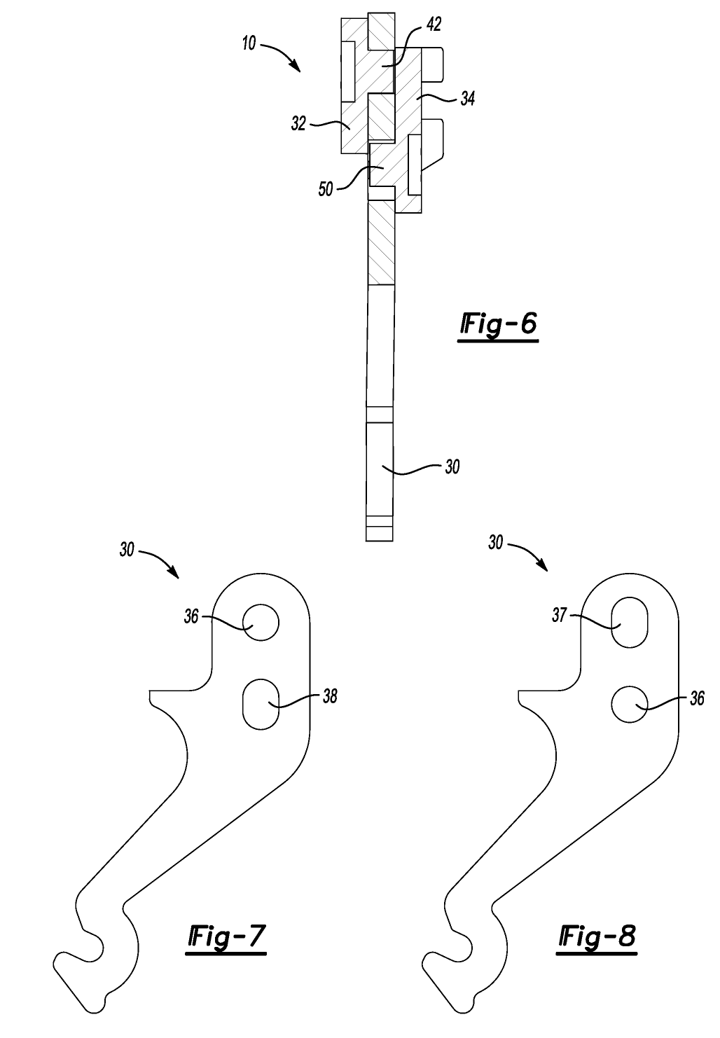

The actuator lever 30 is positioned for longitudinal movement in the gap 56 formed between the first strut and the second strut. Referring to FIG. 6, the first projection 42 penetrates the round aperture 36, and the second projection 50 penetrates the elongated slot 38, for providing pivotal motion of the lever about either or both of the first or second projection. Upon actuation of the lever, and upon pivoting of the lever about either or both of the first or the second projection, the first strut, the second strut or both, move relative to each other for bringing the first strut, the second strut or both in contact with a braking element 18 and actuating the attached friction pad 22 to frictionally engage an opposing braking component, such as a brake drum.

During pivotal movement of the actuator lever 30 about projection 42, projection 42 moves the first strut in a first direction and projection 50 moves the second strut in a second and opposite direction. Preferably, the first and second directions are parallel with each other. Accordingly, to allow for this parallel motion and to prevent binding slot 38 is provided for allowing movement of projection 50 and hence the second strut with respect to the first strut and actuator lever. Of course, as previously discussed and shown in FIGS. 7 and 8, the configuration of aperture 36 and slot 38 may be reversed.

During actuation of the parking brake mechanism, e.g. rotation of the actuator lever 30, the first and second strut move with respect to each other to apply a force suitable for movement of the braking elements 18. To facilitate engagement between the first and second strut with the braking elements, each braking element includes a notch 24 for receiving the first and second strut. These notches assist in maintaining the position of the parking brake mechanism with respect to the braking elements and anchor block 26 during both engagement and non-engagement of the parking brake assembly.

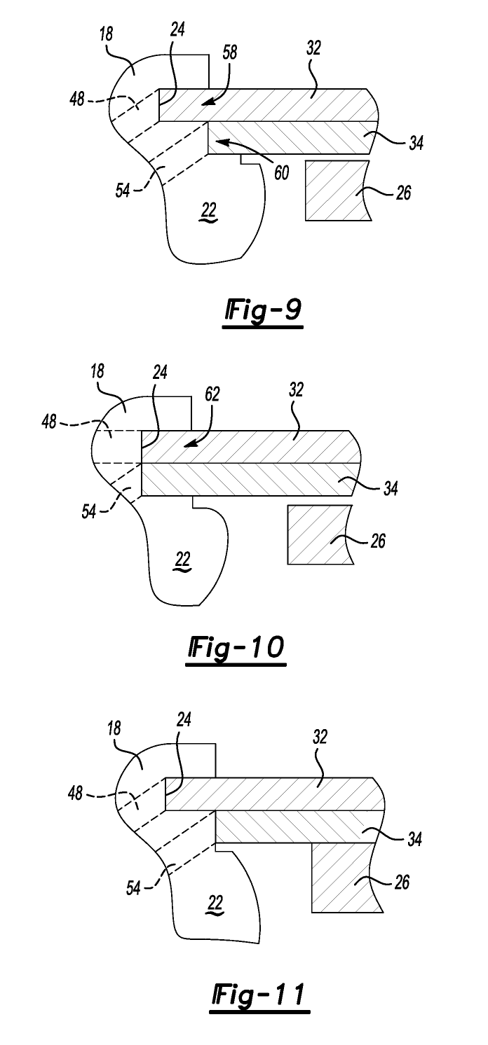

For example, referring to FIGS. 9 through 11, three notch configurations are shown that may be used with the parking brake mechanism of the present invention. FIG. 9 illustrates a first notch configuration wherein the braking element 18 includes a notch 24 having a first seat 58 and a second seat 60 for engagement with the first strut and second strut, respectively. The first seat prevents outward movement of the parking brake mechanism and the second seat prevents inward movement of the parking brake mechanism. FIG. 10 illustrates a second notch configuration where the braking element 18 includes a notch 24 having a single seat 62 for engagement with both the first and second strut. The singe seat 62 is configured to prevent both outward and inward movement of the parking brake mechanism 10 with respect to the braking element. FIG. 11 illustrates a third notch configuration where the braking element includes a notch 24 having a single seat 64 for engagement with first strut. In this configuration, the single seat prevents outward movement of the parking brake actuator while the anchor block 26 prevents inward movement of the parking brake actuator. It should be appreciate that other configurations are contemplated.

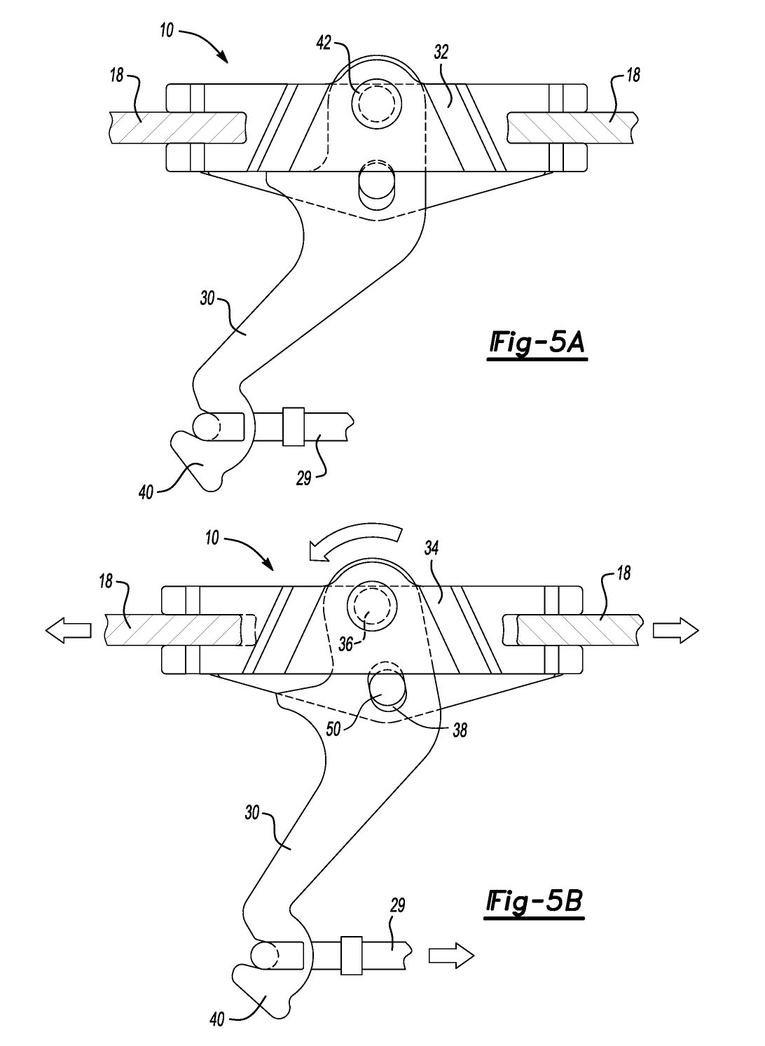

As should be appreciated with the above configurations, the length of the first and second strut and position of corresponding contact surface 44 52 may vary depending on the seat configuration of notch 24. Further, it should also be appreciated, as shown in FIGS. 5A and 5B, that fingers 48 and 54 prevent movement of the parking brake mechanism 10 in a direction perpendicular to the surface of the braking element shown in FIGS. 9 through 11.

The contact area between the actuator mechanism 10 and the braking element 18 may be dependent upon, at least in part, the applied load and friction (and anticipated wear) between the contact surfaces of the actuator mechanism (e.g. struts) and braking element. As previously mentioned, contact between the parking brake mechanism and braking elements comprise axial force against the braking elements, which is substantially parallel with the axial movement of the first and second struts. This axial force results in little to no friction force between the parking brake assembly 10 and the braking element 18, thereby, substantially increasing the life of the parking brake assembly in contrast to sliding, sweeping and/or cammed parking brake systems.

In one embodiment, the contact areas between the struts and the braking element may be considerably smaller than previous brake assemblies. It is anticipated that, due to the reduction in potential surface friction wear, the required contact surface area between the struts and braking element is reduced by at least 5%, or at least 10%, or at least 20%, or at least 50%, or more. While the contact surface may vary, it is contemplated that the contact surface area may be less than 24 mm², 10 mm², more even less than about 5 mm².

The components forming the actuator mechanism 10 may be formed of similar or dissimilar materials. They may be formed of a high strength material, a hardened material (selectively or entirely), or combinations thereof, to translate or receive the application of force to or from other the components of the actuator. Optionally, they may also be configured to resist wear from the rotational movement between the strut members 32, 34 and lever 30, from contact between the strut members and braking elements, and/or from contact between the lever and engagement feature. These contact surfaces may be selectively or entirely coated with friction reducing material, or surface treated for locally hardening or otherwise altering the physical characteristics of the material. This optional wear resistant feature may be derived from the composition of the material forming the actuator components or may comprise applying over some or all of the contacting surfaces a coating, surface treatment, a laminated layer, or any combination thereof. Suitable materials for forming the components of the actuator mechanism include metal, ceramic or other high strength materials. In one configuration the material forming the components comprise a high strength steel such as SAE J1392 050 XLF. However, other materials are available and anticipated with the present invention such as those commonly used in the industry for forming mechanical brake components for vehicles, or otherwise.

The actuator components may be formed using suitable forming techniques for the given material. However, with the use of metal, it is contemplated that the components may be formed through a stamping process, a machining process, or both. Accordingly, in at least one configuration, the activating lever 30, struts 32, 34, or both, may comprise a substantially flat member. The thickness of the actuator components may comprise any suitable thickness. For example, the thickness of the actuator components may be from about 3 mm to about 8 mm. The lever, struts, or both, may be interchangeable and reversible to be configured for placement on a brake assembly located on either side of a vehicle.

It should be appreciated that one or more additional features may be added to further improve the performance capabilities of the present invention. For example, a lubricant may be used between contact surfaces of the components of the actuator mechanism. The lubricant may also be used between the actuator mechanism and other components such as components of the brake assembly, engagement feature, or otherwise. Suitable lubricants include grease or other similar types of lubricants that have surface cohesion properties for maintaining the lubricant on the components in which it is lubricating.

In general, for operation of one of the preferred assemblies herein, the parking brake assembly is activated through an application of force upon the engagement feature. The application of force is translated to one end of the actuator lever 30 via linkage 29 for applying a tensile or compressive force to move the lever, or otherwise. This application of force causes the actuator lever to rotate with respect to the first and second strut 32, 34 as a result of the staggered pivotal connection between the first and second strut. As the actuator lever rotates, through the pivotal connections, the first and second strut moves away from each other, or outwardly, to engage braking elements 18 located on opposite sides of the actuator mechanism 10 and apply a force thereto sufficient to cause the braking elements to move away from each other. This force is greater than the force being applied to the braking elements by the braking member 28 therefor. This movement causes the friction pads 20 of the braking element 18 to engage a corresponding braking component, typically the brake drum, to prevent an associated wheel of the brake assembly from rotating.

Upon release of the engagement feature, the force being applied to the actuator lever 30 is released or otherwise becomes less than the biasing member 28 for the braking elements 18. Through the biasing member, the braking elements move towards the actuator mechanism 10 and each other. This movement results in a force being applied to the strut members 32, 34, which in turn results in a force being applied to the actuator lever to return the lever to an original position.

It has been realized that the features of the present invention have resulted in drastically improved operating cycle of the parking braking assembly. Such improvements have resulted in an increased life span of the parking brake assembly upwards of 2, 4, 6 fold or more. Specifically, the braking assembly has achieved minimum required braking ability over an operating cycle of more than 20,000 cycles. It is also realized that the operating cycle of the braking assembly of the present invention may be substantially greater than 20,000 cycles, including greater than 40,000, 50,000, 75,000, 100,000 or ever greater than 125,000 cycles.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such features may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A parking brake assembly, comprising:
a housing;
one or more braking elements having contact surfaces pivotally mounted with respect to the housing, the one or more braking elements being adapted to rotate outwardly from an axis to provide contact with a corresponding braking component;
an actuating mechanism including:
lever having a first pivot site and a second pivot site;
a first strut pivotally engaging the actuating lever at the first pivot site and having a first longitudinal axis; and
a second strut engaging the actuating lever at the second pivot site and having (i) a second longitudinal axis that is generally in parallel alignment with the first longitudinal axis and (ii) a contact surface engaging a first notch formed in at least one of the braking elements;
wherein upon displacement of the actuating lever the first strut, the second strut or both move generally longitudinally relative to each other for bringing the contact surface of at least one of the braking elements into or out of braking engagement with the corresponding braking component.

2. The assembly of claim 1, wherein the first notch assists in substantially preventing the lever, the first strut and the second strut from separating.

3. The assembly of claim 1, wherein the first strut includes a contact surface for engaging at least one of the braking elements.

4. The assembly of claim 3, wherein the contact surface of the first strut engages the first notch formed in the braking elements.

5. The assembly of claim 3, wherein the one or more braking elements include a second notch located opposite the first notch with respect to the actuating mechanism.

6. The assembly of claim 5, wherein the first strut, the second strut or both include an additional contact surface for engaging the second notch.

7. The assembly of claim 1, wherein substantially no surface friction occurs during engagement of the second strut with the at least one braking elements.

8. The assembly of claim 3, wherein substantially no surface friction occurs during engagement of the first strut with the at least one braking elements.

9. The assembly of claim 1, wherein the actuator is located between the first and second strut.

10. The assembly of claim 9, wherein the housing includes an anchor block for assisting in positioning of the one or more brake elements.

11. The assembly of claim 10, wherein the actuator mechanism is located adjacent the anchor block.

12. The assembly of claim 11, wherein the actuator is located outboard of the anchor block.

13. The assembly of claim 12, wherein the housing includes a backing plate.

14. The assembly of claim 13, wherein the first strut, second strut, lever, or combinations thereof extend through an opening formed in the backing plate.

15. The assembly of claim 10, wherein first notch substantially limits movement of the actuator mechanism away from the anchor block.

16. The assembly of claim 1, wherein the corresponding brake component comprises a brake drum.

17. The assembly of claim 1, wherein the first strut, the second strut, or both, are reversible for installation on or with brake assemblies located on opposite sides of a vehicle.

18. The assembly of claim 16, wherein the lever is reversible for installation on or with brake assemblies located on opposite sides of a vehicle.

19. A parking brake assembly, comprising:
a housing;
one or more braking elements having contact surfaces pivotally mounted with respect to the housing, the one or more braking elements being adapted to rotate outwardly from an axis to provide contact with a corresponding braking component;
an actuating mechanism including:
lever having a first pivot site and a second pivot site;
a first strut pivotally engaging the actuating lever at the first pivot site and having a first longitudinal axis; and
a second strut engaging the actuating lever at the second pivot site and having a second longitudinal axis;
wherein upon displacement of the actuating lever the first strut, the second strut or both move generally longitudinally relative to each other for engaging one or more braking elements to cause the contact surface the braking elements to move into or out of braking engagement with the corresponding braking component, and
wherein the first strut, the second strut and the lever remain substantially together during operation of the parking brake assembly.

20. An actuator mechanism for a parking brake, the assembly including:
lever having a first pivot site and a second pivot site;
a first strut pivotally engaging the actuating lever at the first pivot site and having a first longitudinal axis; and
a second strut engaging the actuating lever at the second pivot site and having a second longitudinal axis;
wherein upon displacement of the actuating lever, the first strut, the second strut or both are translated generally longitudinally relative to each other for engaging one or more braking elements to cause contact surface of the braking elements to move into or out of braking engagement with the corresponding braking component,
wherein positioning of the actuating mechanism is achieved through the engagement with the one or more braking elements, and
wherein the first strut, second strut and lever are reversible for installation with brake assemblies located on opposite sides of a vehicle.
